(19) United States
(12) Patent Application Publication
(10) Pub. No.: US 2026/0258233 A1
(43) Pub. Date: Sep. 3, 2026

(54) Decabromo-Diphenyl Ethane Free Flame Retardant Thermoplastic Composition

(71) Applicant: LANXESS Corporation, Pittsburgh, PA (US)

(72) Inventors: Qingliang He, Cheshire, CT (US); Patrick Jacobs, Essen (BE); Christopher Simpson, Hamden, CT (US); Otto Mauerer, Leichlingen (DE); Heiko Tebbe, Dormagen (DE)

(73) Assignee: LANXESS Corporation, Pittsburgh, PA (US)

(21) Appl. No.: 19/162,119

(22) PCT Filed: Mar. 5, 2024
(86) PCT No.: PCT/US2024/018495

§ 371 Date: Sep. 4, 2025

Related U.S. Application Data
(60) Provisional application No. 63/450,113, filed on Mar. 6, 2023.

(51) Int. Cl. C08L 23/06; C08K 3/22; C08K 5/136; C08K 5/52; C08L 23/12; C08L 25/18; C08L 53/02

(52) U.S. Cl. CPC C08L 23/06; C08K 3/2279; C08K 5/136; C08K 5/5205; C08L 23/12; C08L 25/18; C08L 53/025; C08L 2201/02; C08L 2205/03

(57) ABSTRACT

A method of replacing decabromodiphenyl ethane in a flame retardant thermoplastic composition by combining (a) a thermoplastic polymer; (b) an aromatic brominated flame retardant that is not decabromodiphenyl ethane; and (c) a synergist for the aromatic brominated flame retardant. A flame retardant thermoplastic composition that is free of decabromodiphenyl ethane contains (a) a thermoplastic polymer, (b) an aromatic brominated flame retardant that is not decabromodiphenyl ethane; and (c) a synergist for the aromatic brominated flame retardant.

### FIELD OF INVENTION

The present invention relates to methods of replacing decabromodiphenyl ethane brominated flame retardants in thermoplastic polymer compositions and to flame retardant thermoplastic compositions that are free of decabromodiphenyl ethane.

### BACKGROUND

Halogenated flame retardants are well known and widely available. These products are used in various polymeric compositions and provide varying levels of flame retardance for various applications, such as wire and cables. These products can provide good flame retardance if incorporated at high loadings, but these high loadings make it difficult to achieve a balance of desired properties, e.g., mechanicals (such as crush resistance), electricals (such as wet insulation resistance), and extrusion (such as die pressure observed).

Decabromodiphenyl ethane (DBDPE) is a general purpose, brominated, high-purity, non-DPO (Diphenyl oxide) based flame retardant for a variety of polymers including styrenics, engineering polymers, polyolefins, and elastomers, which is commercially available from LANXESS under the tradename Firemaster® 2100R. DBDPE is one of the only “universally” applicable flame retardants in use today. DBDPE, however, has come under certain increased regulatory-based scrutiny. Therefore, there is a desire to have DBDPE-free flame retardant compositions that are suitable for use in a variety of polymers, and particularly polyolefins, such as those used in wire and cable constructions.

Various brominated alternatives to DBDPE are sold and have been proposed for various polymer applications.

For example, US 2020/0216650A1 discloses silane-functionalized compositions comprising 16-70 wt % polymeric brominated flame retardant with a weight average molecular weight (Mw) of equal to or greater than (≥) 1,000 g/mol for use with wire and cable constructions. Exemplary brominated flame retardants are brominated polyphenyl ether (Emerald Innovation™ 1000) and brominated styrene/butadiene block copolymer (Emerald Innovation™ 3000). The compositions further contain 0.3-5 wt % or 10-79 wt % of alkoxysilane.

U.S. Pat. No. 8,420,876 discloses preparation of oligomeric or polymeric mixtures comprising 1,3-diphenylpropane, 1,3,5-triphenylpentane, 1,3,5,7-tetraphenylheptane, and 1,3,5,7,9-pentaphenylnonane with a polydispersity greater than 1.25 that are suited for bromination as flame retardants for polyurethane foam applications.

U.S. Pat. No. 8,642,821 discloses processes for producing a brominated flame retardant composition, the process comprising brominating a feed comprising an anionic, chain transfer derived toluene and styrene telomer distribution in the presence of a catalytic quantity of AlBr₃ and a solvent. Resulting flame retardants may be suitable for a variety of thermoplastics although no formulated examples are provided.

One of the deficiencies of these disclosures is that either no, or only horizontal, burn results were provided. Horizonal burn testing is a significantly less demanding test than the UL-94 vertical test. There is a need for alternatives to existing DBDPE-free flame retardant compositions that are effective in vertical burn tests.

It is an object of this disclosure to provide flame retardant compositions that are free of DBDPE, which show efficacy in vertical burn tests. It is desirable for such compositions to be used in thermoplastic polyolefin compositions. Thus, it is also an object to provide thermoplastic polyolefin compositions, such as polyolefins used for wire and cables, comprising flame retardants that are free of DBDPE.

### SUMMARY OF INVENTION

This disclosure provides a method of replacing decabromodiphenyl ethane in a flame retardant thermoplastic composition, particularly those containing polyolefins, such as polypropylene or polyethylene. A DBDPE-free thermoplastic polyolefin composition is prepared by combining
(a) at least one thermoplastic polyolefin;
(b) at least one aromatic brominated flame retardant that is not decabromodiphenyl ethane; and
(c) at least one synergist.

The method can further comprise molding the flame retardant thermoplastic composition into an article. In certain embodiments, the flame retardant thermoplastic composition is free of an alkoxysilane, an alkoxysilane functionalized polymer and/or a silanol condensation catalyst.

Also described herein are flame retardant thermoplastic compositions that are free of decabromodiphenyl ethane comprising:
(a) at least one thermoplastic polyolefin;
(b) at least one aromatic brominated flame retardant that is not decabromodiphenyl ethane; and
(c) at least one synergist.

In some embodiments, the flame retardant thermoplastic composition does not include an alkoxysilane, an alkoxysilane functionalized polymer and/or a silanol condensation catalyst.

Advantageously, the methods and compositions described herein do not require use of an alkoxysilane, an alkoxy functionalized polymer and/or a silanol condensation catalyst like those described in US 2020/0216650A1. Moreover, the present methods and compositions provide thermoplastic articles that meet requirements of UL 94 Tests for Flammability of Plastic Materials for Parts in Devices and Appliances Dec. 1, 2021. Preferably, a molded article of the composition has a UL 94 V0 rating at a thickness of 0.2 mm to 3.2 mm, such as at a thickness of about 0.2 mm, about 0.4 mm, about 0.8 mm, about 1.6 mm, and about 3.2 mm.

The methods and flame retardant thermoplastic compositions may further comprise one or more of the following: (d) at least one auxiliary process aid, such as at least one antioxidant and/or at least one heat stabilizer; and (e) at least one inorganic filler, including but not limited to talc.

The flame retardant thermoplastic composition typically compromises the (b) aromatic brominated flame retardant in an amount of from about 5 wt % to about 40 wt % and the (c) at least one synergist in an amount of from about 1 wt % to about 20 wt %, each based on the total weight of the composition.

The thermoplastic polyolefin may be filled or unfilled. In some embodiments, the (a) at least one thermoplastic polyolefin comprises or is polypropylene. In other embodiments, the (a) polyolefin comprises or is polyethylene.

In certain preferred embodiments, the (b) at least one aromatic brominated flame retardant is selected from a Phenoxy-terminated carbonate oligomer of Tetrabromobisphenol A, a homopolymer of dibromostyrene, or Poly(2,6-dibromophenol oxide). In certain of those embodiments, the (b) aromatic brominated flame retardant is a Phenoxy-terminated carbonate oligomer of Tetrabromobisphenol A.

In some embodiments, a ratio of the (b) at least one aromatic brominated flame retardant to the (c) at least one synergist is about 1:10 to about 10:1, preferably about 1:1 to about 5:1, more preferably about 1:1 to about 3:1. In preferred embodiments, the (c) at least one synergist comprises antimony and/or melamine polyphosphate.

In certain embodiments, the (c) at least one synergist comprises an aliphatic brominated flame retardant. In certain of those embodiments, a ratio of the aromatic brominated flame retardant to the aliphatic brominated flame retardant is about 1:1 to about 2:1. In some embodiments, the aromatic brominated flame retardant is a Phenoxy-terminated carbonate oligomer of Tetrabromobisphenol A, and the aliphatic brominated flame retardant is a brominated styrene/butadiene block copolymer.

In some particular embodiments, the (a) thermoplastic polymer is unfilled, the (c) synergist comprises an aliphatic brominated flame retardant, and a ratio of the (b) aromatic brominated flame retardant to the aliphatic brominated flame retardant is about 1:1 to about 2:1. In certain of these embodiments, the aromatic brominated flame retardant is a Phenoxy-terminated carbonate oligomer of Tetrabromobisphenol A, and the aliphatic brominated flame retardant is a brominated styrene/butadiene block copolymer.

Also described is a method of making said flame retardant thermoplastic compositions; and an article containing the thermoplastic polymer composition.

It is to be understood that both the foregoing general description and the following detailed description are exemplary and explanatory only and are not restrictive of the invention, as claimed.

### DETAILED DESCRIPTION

This disclosure concerns methods for replacing decabromodiphenyl ethane in a flame retardant thermoplastic composition. The thermoplastic polymer may be a polyester, polyamide, polystyrene, including high impact polystyrene (HIPS), polyolefin, polycarbonate, polyurethane, polyphenylene ether, or other thermoplastic polymer. More than one thermoplastic polymer (thermoplastic polymer blends) can be used, such as polyphenylene ether/styrenic resin blends, polyvinyl chloride/acrylonitrile butadiene styrene (ABS) or other impact modified polymers, such as methacrylonitrile and α-methylstyrene containing ABS, and polyester/ABS or polycarbonate/ABS. The thermoplastic polymer may be unreinforced or reinforced, for example, glass reinforced, such as a glass-filled polyester (e.g., glass-filled polyalkylene terephthalate) or a glass-filled polyamide.

Illustrative polymers are: olefin polymers, cross-linked and otherwise, for example homopolymers of ethylene, propylene, and butylene; copolymers of two or more of such alkene monomers and copolymers of one or more of such alkene monomers and other copolymerizable monomers, for example, ethylene/propylene copolymers, ethylene/ethyl acrylate copolymers and ethylene/propylene copolymers, ethylene/acrylate copolymers and ethylene/vinyl acetate copolymers; polymers of olefinically unsaturated monomers, for example, polystyrene, e.g. high impact polystyrene, and styrene copolymers, polyurethanes. Preferably, the polyolefin is polypropylene and/or polyethylene.

The at least one thermoplastic polymer (a) is often present in the flame retardant thermoplastic composition in an amount of from about 30 to about 95 wt %, such as from about 40 to about 90 wt % or from about 50 to about 90 wt %, based on the total weight of the flame retardant thermoplastic composition.

The aromatic brominated flame retardant is not DBDPE and is typically a brominated aromatic polymer or oligomer.

Exemplary brominated flame retardants that can be used in the compositions herein include aromatic and aliphatic brominated flame retardants, such as a brominated styrene/butadiene block copolymer (e.g., Emerald Innovation™ 3000), a Phenoxy-terminated carbonate oligomer of Tetrabromobisphenol A (e.g., BC-58™), a homopolymer of dibromostyrene (e.g., Firemaster® PBS-64 HW), 1,1′-(isopropylene) bis[3,5-dibromo-4-(2,3-dibromo-2-methylpropoxy)benzene] (SR-130), ethylenebistetrabromophthalimide (SAYTEX® BT-93), a brominated triazine, such as Tris(Tribromophenoxy) triazine (e.g., FR-245), Poly(2,6-dibromophenol oxide) (UNIPLEX FRP 64), polybromostyrene copolymerized with another monomer (e.g., Firemaster® CP-44HF), and combinations thereof.

In certain preferred embodiments, the aromatic brominated flame retardant is selected from a Phenoxy-terminated carbonate oligomer of Tetrabromobisphenol A, a homopolymer of dibromostyrene, or Poly(2,6-dibromophenol oxide).

The amount of aromatic brominated flame retardant (b) used in the flame retardant thermoplastic composition will be that quantity needed to obtain the flame retardancy sought. In general, the composition and resultant product may contain from about 1 to about 40 wt %, preferably about 5 to about 40 wt %, such as about 15 to about 30 wt % or from about 5 to about 25 wt % of a brominated flame retardant. Master batches of polymer containing an aromatic brominated flame retardant, which are blended with additional amounts of substrate polymer or binding agent, typically contain even higher concentrations of the flame retardant, e.g., up to 95 wt % or more.

In certain instances, a combination of brominated flamed retardants may be used in a thermoplastic formulation. The combination utilized may depend on the thermoplastic material. For instance, it has surprisingly been found that the combination of an aromatic brominated flame retardant, such as a Phenoxy-terminated carbonate oligomer of Tetrabromobisphenol A, can show a synergistic effect when combined with an aliphatic brominated flame retardant, such as a brominated styrene/butadiene block copolymer, in polypropylene and polyethylene. In such a case, the aliphatic brominated flame retardant will act as a synergist (component c) for the aromatic brominated flame retardant (component b).

Examples of additional flame retardant synergists (c) include antimony, condensation, products of melamine (e.g., melam, melem, melon), melamine cyanurate, reaction products of melamine with polyphosphoric acid (e.g., dimelamine pyrophosphate, melamine polyphosphate), reaction products of condensation products of melamine with polyphosphoric acid (e.g., melem polyphosphate, melam polyphosphate, melon polyphosphate), melamine-poly(metal phosphate) (e.g., melamine-poly(zinc phosphate), a triazine-based compound, such as a reaction product of trichlorotriazine, piperazine and morpholine, e.g., poly-[2,4-(piperazine-1,4-yl)-6-(morpholine-4-yl)-1,3,5-triazine]/piperazin (e.g., MCA® PPM Triazine HF), an organic phosphinate, such as aluminum dialkylphosphinate, e.g., aluminum diethylphosphinate (Exolit® OP); and aluminum hydrogen phosphite (Al₂(HPO₃)₃).

In certain embodiments, a synergist is a nitrogen-containing synergist. Suitable nitrogen-containing synergists may be chosen from, e.g., melamine derivatives such as melamine and its condensation products (melam, melem, melon or similar compounds with higher condensation levels), melamine cyanurate, and phosphorus/nitrogen compounds such as dimelamine phosphate, dimelamine pyrophosphate, melamine phosphate, melamine pyrophosphate, melamine polyphosphate, melam polyphosphate, melon polyphosphate, and melem polyphosphate, and mixed polysalts thereof.

Examples of additional flame retardants suitable as a synergist include halogenated flame retardants, alkyl or aryl phosphine oxide flame retardants, alkyl or aryl phosphate flame retardants, alkyl or aryl phosphonates, alkyl or aryl phosphinates, and salts of alkyl or aryl phosphinic acid. Often, the additional flame retardant is an alkyl or aryl phosphate (e.g., triphenyl phosphate, bisphenol-A bis(diphenyl phosphate), resorcinol bis(diphenyl phosphate), or resorcinol bis(dixylenyl phosphate).

In some embodiments, the synergist is a phosphorous based flame retardant For instance, when an aromatic brominated flame retardant, such as a Phenoxy-terminated carbonate oligomer of Tetrabromobisphenol A was used with unfilled polyethylene, a synergistic result was found with melamine polyphosphate. It is envisioned that alternative phosphorous based flamed retardants would have a similar effect.

In other embodiments, when mineral filled polyethylene was used, an aliphatic brominated flame retardant, such as a homopolymer of dibromostyrene, was utilized as a synergist.

In preferred embodiments, it is advantageous to use the brominated flame retardants disclosed herein in combination with antimony-based synergists, e.g., Sb₂O₃. Generally, the flame retardant products of this invention will be used with the antimony-based synergists in a weight ratio ranging from about 1:1 to 7:1, and preferably of from about 1:1 to about 3:1.

As demonstrated herein, use of a nitrogen-containing synergist or nitrogen-containing flame retardant is not necessary to obtain excellent flame retardant performance and processing stability in thermoplastic polymer applications when using the combination of the aromatic bromine-containing flame retardant and synergist of the present disclosure. Thus, in some embodiments, the thermoplastic flame retardant composition of the present disclosure does not include a nitrogen-containing synergist or nitrogen-containing flame retardant.

The amount of synergist will typically range from about 1 to about 20 wt %, such as about 10 to about 15 wt % of the thermoplastic composition.

The thermoplastic composition may consist essentially of or consist of the components (a), (b), and (c) and, optionally, any one or combination of components (d) and (e).

Auxiliary process-aids (d) and filler (e) are typically employed in an amount less than 10 percent by weight of the flame retardant thermoplastic composition, e.g., often less than 5 percent by weight, such as 3 wt % or less. Non-limiting examples of auxiliary process-aids (d) include antioxidants, UV stabilizers, lubricants, impact modifiers, plasticizers, acid scavengers (e.g., carbodiimides or epoxides), phosphine suppressants, pigments, dyes, optical brighteners, anti-static agents, anti-dripping agents, e.g., PTFE, and other additives used to enhance the properties of the resin.

The thermoplastic composition may comprise one or more heat stabilizers. Examples of suitable heat stabilizers include metal hydroxides, oxides, oxide hydrates, borates, molybdates, carbonates, sulfates, phosphates, silicates, siloxanes, stannates, mixed oxide-hydroxides, oxide-hydroxide-carbonates, hydroxide-silicates, hydroxide-borates, preferably where the metal is zinc, magnesium, calcium or manganese, often zinc. For example, one or more heat stabilizers may be chosen from zinc borate, zinc stannate, zinc molybdate complex (e.g., Kemgard® 911B), zinc molybdate/magnesium hydroxide complex (e.g., Kemgard® MZM), zinc molybdate/magnesium silicate complex (e.g., Kemgard® 911C), calcium molybdate/zinc complex (e.g., Kemgard® 911A), and zinc phosphate complex (e.g., Kemgard® 981), montmorillonite, kaolinite, halloysite, and hydrotalcite. When present, the amount of the at least one heat stabilizer is often from 0.1 to 5 wt %, based on the total weight of the flame retardant thermoplastic composition.

At least one inorganic filler may be present in the flame retardant thermoplastic composition. As known in the art, an inorganic filler can reduce the molding shrinkage coefficient and linear expansion coefficient of a resultant molded article and improve high and low heat shock property. Various fillers in the form of fiber or non-fiber (e.g., powder, plate) may be used depending on the desired article. Some examples of fibrous filler, which are types of inorganic filler, may be those such as, glass fiber, glass fiber having a non-circular cross section, such as flat fiber, carbon fiber, silica fiber, silica alumina fiber, zirconia fiber, boron nitride fiber, silicon nitride fiber, boron fiber, potassium titanate fiber, and further, metal fibrous substances such as stainless, aluminum, titanium, copper and brass. Typical fibrous filler is glass fiber or carbon fiber. Alternatively, the inorganic filler may be a powdery filler, such as carbon black, graphite, silica, quartz powder, glass bead, glass powder, calcium silicate, kaolin, talc, clay, diatomaceous earth, silicates, such as wollastonite, metal oxides, such as iron oxide, titanium oxide, zinc oxide and alumina, metal hydroxides, metal carbonates, such as calcium carbonate and magnesium carbonate, metal sulfates, such as calcium sulfate and barium sulfate, silicon carbide, silicon nitride, boron nitride and various metal powders. Another example of inorganic filler is plate-like filler such as mica, glass flake and various metal foils. These inorganic fillers can be used alone or in combination of two or more. In use, the inorganic fillers are desirably treated previously with a sizing agent or surface treatment agent, if necessary.

When present, the amount of the at least one inorganic filler (e) in the flame retardant thermoplastic composition is often from 1 to 50 wt %, e.g., from 5 to 50 wt %, from 10 to 40 wt %, or from 15 to 30 wt %, based on the total weight of the flame retardant thermoplastic composition.

Thermoplastic articles formed from formulations containing a thermoplastic polymer and a brominated flame retardant composition described herein can be produced conventionally, e.g., by injection molding, extrusion molding, compression molding, and the like. Blow molding may also be appropriate in certain cases.

The desired product is, in one embodiment, a molded article of the composition, which achieves a UL 94 V0 rating at a thickness of 0.4 mm, 0.8 mm, 1.6 mm, or between 0.2 mm and about 3.2 mm.

Achieving excellent flame performance, (UL 94 V0) for thin wall articles (e.g., 0.8 mm and thinner) requires achieving short flame out times while preventing flaming drips during UL 94 testing. Short flame out times are usually achieved using flame retardant agents while flaming drips may be prevented by adding anti-drip agents.

The following Examples are illustrative of the flame retardant thermoplastic formulations of this disclosure.

### Examples

A twin screw extruder was used to compound the formulations shown in Table 1 at barrel temperature of 200-220° C. The amount of brominated flame retardant was 30 wt % to assess suitability as a replacement for DBDPE in the exemplary polyolefins used in wire and cable articles. An injection molder was used to prepare samples of various thicknesses at 200-220° C. and a mold temperature at 50-60° C. The formulations were evaluated for flame retardant activity under UL-94 vertical burning test and processing stability. “V-0” refers to highest rating; “V-2” refers to lowest rating before fail.

TABLE 1
Talc filled polypropylene with 15-30 wt % aromatic BrFRs

| | UL94 @ | UL94 @ |
|---|---|---|
| | 1.6 mm | 1.6 mm |
| % FR in 20% talc filled PP | (48 h) | (7 days) |
| 30 PBS-64HW/10 ATO | V-0 | V-0 |
| 15 PBS-64HW/15 EI3000/10 ATO | fail | fail |
| 30 PBS-64HW/1 ZnB/10 ATO | V-0 | V-0 |
| 30 PBS-64HW/2 ZnB/10 ATO | V-0 | V-0 |
| 15 PBS-64HW/15 EI3000/1 ZnB/10 ATO | fail | fail |
| 15 PBS-64HW/15 El3000/2 ZnB/10 ATO | fail | fail |
| 30 BC-58/10 ATO | V-0 | V-2 |
| 15 BC-58/15 El 3000/10 ATO | fail | fail |
| 30 CP-44HF/10 ATO | V-2 | V-2 |
| 15 CP-44HF/15 EI 3000/10 ATO | fail | fail |

PBS-64HW = Firemaster ® PBS-64 HW (LANXESS)
ATO = antimony trioxide
El3000 = Emerald Innovation ™ 3000 (LANXESS)
ZnB = zinc borate
BC-58 = BC-58 ™ (LANXESS)
CP-44HF = Firemaster ® CP-44HF (LANXESS)

As shown in Table 1, inclusion of 30 wt % of various aromatic brominated flame retardants (BrFR) with antimony trioxide in inorganic filled polypropylene achieved UL-94 V-0 at 1.6 mm thickness whereas the same result was not seen for 15 wt % of aromatic BrFR. Supplementing the aromatic flame retardant with an aliphatic flame retardant did not result in suitable flame retardancy.

TABLE 2
Unfilled polypropylene with 15-30 wt % aromatic BrFR

| | UL94 @ | UL94 @ |
|---|---|---|
| | 3.2 mm | 3.2 mm |
| % FR in unfilled PP | (48 h) | (7 days) |
| 30 BC-58/10 ATO | fail | fail |
| 15 BC-58/15 EI3000/10 ATO | V-0 | N/A |
| 20 BC-58/10 EI3000/10 ATO | V-0 | N/A |
| 22.5 BC-58/7.5 EI3000/10 ATO | V-0 | N/A |
| 30 EI3000/10 ATO | fail | fail |
| 30 PBS-64HW/10 ATO | fail | fail |
| 30 FRP-64P/10 ATO | fail | fail |

PBS-64HW = Firemaster ® PBS-64 HW (LANXESS)
ATO = antimony trioxide
El3000 = Emerald Innovation ™ 3000 (LANXESS)
BC-58 = BC-58 ™ (LANXESS)
N/A: not available

In contrast to talc filled polypropylene of Example 1, the unfilled polypropylene did not benefit from inclusion of 30% aromatic brominated flame retardant with antimony synergist. However, when the aromatic flame retardant was supplemented with aliphatic brominated flame retardant wherein the ratio of aromatic brominated flame retardant to aliphatic brominated flame retardant was greater than 1:1, the aromatic brominated flame retardants with antimony synergist achieved UL-94 V-0 at 1.6 mm thickness.

TABLE 3
Unfilled polyethylene with 15-30 wt % aromatic BrFR

| | UL94 @ | UL94 @ |
|---|---|---|
| | 1.6 mm | 1.6 mm |
| % FR in unfilled PE | (48 h) | (7 days) |
| 30 BC-58/10 ATO | V-0 | V-0 |
| 15 BC-58/15 EI3000/10 ATO | V-0 | V-0 |
| 27.6 BC-58/11.1ATO/5.6MPP | V-0@ 2 mm | V-0@ 2 mm |
| 30 FRP-64P/10 ATO | V-0 @ 3.2 mm | V-0 @ 3.2 mm |
| | V-2 @ 1.6 mm | V-2 @ 1.6 mm |

ATO = antimony trioxide
El3000 = Emerald Innovation ™ 3000 (LANXESS)
BC-58 = BC-58 ™ (LANXESS)
MPP = melamine polyphosphate
FR64P = UNIPLEX ™ FRP-64P (LANXESS)

In contrast to the unfilled polypropylene of Example 2, the unfilled polyethylene achieved UL-94 V-0 at 1.6 mm thickness by inclusion of 30% aromatic bromine flame retardant with antimony synergist as well as with 1:1 ratio of aromatic brominated flame retardant to aliphatic brominated flame retardant.

It was concluded that DBDPE can be successfully replaced in polyolefin formulations by other aromatic and aliphatic brominated flame retardants when used with antimony alone or with other synergists. The examples utilize polyolefins. However, it is envisioned that the disclosed flame retardant compositions may be suitable for other polymers, such as HIPS (high impact polystyrene) and ABS (acrylonitrile butadiene styrene). In such cases, it may be necessary to adjust the amount of aliphatic and aromatic flame retardant used to replace DBDPE and/or the amount of synergist.

The invention may comprise, consist or consist essentially of the materials and/or procedures recited herein. In particular, the following embodiments are within the scope of this disclosure:

1. A flame retardant thermoplastic composition that is free of decabromodiphenyl ethane comprising:
(a) a thermoplastic polyolefin polymer;
(b) an aromatic brominated flame retardant that is not decabromodiphenyl ethane; and
(c) a synergist for the aromatic brominated flame retardant.

2. The flame retardant thermoplastic composition of embodiment 1, wherein a molded article of the composition has a UL 94 V0 rating at a thickness of between 0.2 mm and 3.2 mm.

3. The flame retardant thermoplastic composition of embodiments 1 or 2, wherein the aromatic brominated flame retardant is a Phenoxy-terminated carbonate oligomer of Tetrabromobisphenol A, a homopolymer of dibromostyrene, or Poly(2,6-dibromophenol oxide).

4. The flame retardant thermoplastic composition according to any of embodiments 1-3, wherein the synergist comprises antimony and/or melamine polyphosphate.

5. The flame retardant thermoplastic composition according to any of embodiments 1-5, wherein a ratio of the aromatic brominated flame retardant to the synergist is about 1:10 to 10:1.

6. The flame retardant thermoplastic composition according to any of embodiments 1-5, wherein the aromatic brominated flame retardant is about 5-40 wt % of the composition.

7. The flame retardant thermoplastic composition according to any of embodiments 1-6, wherein the synergist is about 1 wt % to about 20 wt % of the composition.

8. The flame retardant thermoplastic composition according to any of embodiments 1-7, further comprising at least one auxiliary process-aid, such as an antioxidant or a heat stabilizer.

9. The flame retardant thermoplastic composition according to any of embodiments 1-8, further comprising inorganic filler.

10. The flame retardant thermoplastic composition according to any of embodiments 1-8, wherein the synergist comprises an aliphatic brominated flame retardant.

11. The flame retardant thermoplastic composition according to embodiment 10, wherein a ratio of the aromatic brominated flame retardant to the aliphatic brominated flame retardant is about 1:1 to about 2:1.

12. The flame retardant thermoplastic composition according to embodiment 11, wherein the thermoplastic polymer is unfilled.

13. The flame retardant thermoplastic composition according to any of embodiments 10-12, wherein the aromatic brominated flame retardant is a Phenoxy-terminated carbonate oligomer of Tetrabromobisphenol A, and the aliphatic brominated flame retardant is a brominated styrene/butadiene block copolymer.

14. The flame retardant thermoplastic composition according to any of embodiments 1-5, wherein the thermoplastic polymer is filled.

15. A method of preparing a decabromodiphenyl ethane-free flame retardant thermoplastic composition comprising combining:
(a) a thermoplastic polyolefin polymer;
(b) an aromatic brominated flame retardant that is not decabromodiphenyl ethane; and
(c) a synergist for the aromatic brominated flame retardant.

16. The method of embodiment 15, wherein the wherein the aromatic brominated flame retardant is a Phenoxy-terminated carbonate oligomer of Tetrabromobisphenol A, a homopolymer of dibromostyrene, or Poly(2,6-dibromophenol oxide).

17. The method according to embodiments 15 or 16, wherein the synergist comprises antimony and/or melamine polyphosphate.

18. The method according to any of embodiments 15-17, wherein a ratio the aromatic brominated flame retardant to the synergist is about 1:1 to 3:1.

19. The method according to any of embodiments 15-18, wherein the thermoplastic polymer is unfilled, the synergist comprises an aliphatic brominated flame retardant, and a ratio of the aromatic brominated flame retardant to the aliphatic brominated flame retardant is about 1:1 to about 2:1.

20. The method according to embodiment 19, wherein the aromatic brominated flame retardant is a Phenoxy-terminated carbonate oligomer of Tetrabromobisphenol A, and the aliphatic brominated flame retardant is a brominated styrene/butadiene block copolymer.

1. A flame retardant thermoplastic composition that is free of decabromodiphenyl ethane comprising:
(a) a thermoplastic polyolefin polymer;
(b) an aromatic brominated flame retardant selected from a Phenoxy-terminated carbonate oligomer of Tetrabromobisphenol A and a homopolymer of dibromostyrene; and
(c) an aliphatic brominated flame retardant,
wherein a ratio of the aromatic brominated flame retardant to the aliphatic brominated flame retardant is about 1:1 to about 3:1.

2. The flame retardant thermoplastic composition of claim 1, wherein a molded article of the composition has a UL 94 V0 rating at a thickness of between 0.2 mm and 3.2 mm.

3. (canceled)

4. The flame retardant thermoplastic composition according to claim 1, further comprising antimony and/or melamine polyphosphate.

5. (canceled)

6. The flame retardant thermoplastic composition according to claim 1, wherein the aromatic brominated flame retardant is about 5-40 wt % of the composition.

7. The flame retardant thermoplastic composition according to claim 1, wherein the aliphatic brominated flame retardant is about 1 wt % to about 20 wt % of the composition.

8. The flame retardant thermoplastic composition according to claim 1, further comprising at least one auxiliary process-aid.

9. (canceled)

10. (canceled)

11. (canceled)

12. The flame retardant thermoplastic composition according to claim 1, wherein the thermoplastic polymer is unfilled.

13. The flame retardant thermoplastic composition according to claim 1, wherein the aliphatic brominated flame retardant is a brominated styrene/butadiene block copolymer.

14. (canceled)

15. A method of preparing a decabromodiphenyl ethane-free flame retardant thermoplastic composition comprising combining:
(a) a thermoplastic polyolefin polymer;
(b) an aromatic brominated flame retardant selected from Phenoxy-terminated carbonate oligomer of Tetrabromobisphenol A and a homopolymer of dibromostyrene; and
(c) an aliphatic brominated flame retardant,
wherein a ratio of the aromatic brominated flame retardant to the aliphatic brominated flame retardant is about 1:1 to about 3:1.

16. (canceled)

17. The method according to claim 15, wherein the composition further comprises antimony and/or melamine polyphosphate.

18. (canceled)

19. The method according to claim 15, wherein the thermoplastic polyolefin polymer is unfilled.

20. The method according to claim 19, wherein the aromatic brominated flame retardant is a Phenoxy-terminated carbonate oligomer of Tetrabromobisphenol A, and the aliphatic brominated flame retardant is a brominated styrene/butadiene block copolymer.

21. The method according to claim 15, wherein the polyolefin polymer is polypropylene or polyethylene.

22. The flame retardant thermoplastic composition according to claim 1, wherein the polyolefin polymer is polypropylene or polyethylene.

23. The flame retardant thermoplastic composition according to claim 1, wherein the aromatic brominated flame retardant is about 15 wt % to about 30 wt % of the composition.

24. A flame retardant thermoplastic composition that is free of decabromodiphenyl ethane comprising:
(a) at least one polyolefin polymer selected from polypropylene and polyethyelene;
(b) about 5 wt % to about 40 wt %, based on total weight of the thermoplastic composition, of a Phenoxy-terminated carbonate oligomer of Tetrabromobisphenol A;
(c) about 1 wt % to about 20 wt %, based on total weight of the thermoplastic composition, of a brominated styrene/butadiene block copolymer; and
(d) antimony and/or melamine polyphosphate,
wherein a ratio of the Phenoxy-terminated carbonate oligomer of Tetrabromobisphenol A to the brominated styrene/butadiene block copolymer is about 1:1 to about 3:1,
wherein the composition is unfilled.
